(19) United States
(12) Patent Application Publication
(10) Pub. No.: US 2004/0173996 A1
(43) Pub. Date: Sep. 9, 2004

(54) Computer trolley

(76) Inventor: Robert Paul Anderson, Comstock Park, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/383,405

(22) Filed: Mar. 7, 2003

(51) Int. Cl. B62B 1/00

(52) U.S. Cl. 280/651

(57) ABSTRACT

A computer trolley is disclosed for rollingly supporting computer cases, or other structures. The trolley includes a number of pivotable arms which are each pivotable about their own pivot axis. In-line wheels may be rotatably attached to the ends of each arm. The in-line wheels may use precision ball bearings commonly found in in-line skates. Each end of the arms may include a rotatable corner body that is rotatable to accommodate computer cases of varying widths. A removable pedestal may be included that can be attached underneath the center of the trolley to provide additional load support.

### BACKGROUND OF THE INVENTION

The present invention relates to trolleys that retain computer processing units. More particularly, the field of the invention relates to a trolley structure that is a movable platform for the storage of computer hardware.

The advent of the desktop computer has created multitudinous opportunities for organizing and deploying various elements of the computer system. One element of the desktop computer system that has traditionally been frustrating in terms of the storage options that are reasonably available is the central processing unit (CPU) itself.

Typically the CPU is housed in a case that is usually rectangular in construction. The composition of the case is usually a light gauge steel material, although portions of the case may be fabricated from plastic materials as well.

The CPU will typically house not only the circuitry that comprises the mother board, but usually other peripherals such as hard drives, disk drives, various input and output boards and the like. The internal framework is constructed to contain their individual elements and integrates with the case. The result is a unit that can have a significant amount of weight associated with it, given its size. Some CPUs may weigh up to nearly 50 pounds, depending on the particular system.

The term “desk top” computer has in reality become somewhat of a misnomer. Efficiencies in office planning have made workspace surfaces highly valuable; therefore, elimination of the CPU from the desktop area is now a preferred practice. In this regard, some approaches have been taken to provide cabinetry underneath the work surface in which the CPU may be stored. In these circumstances, access to the rear of the CPU for making various connections becomes difficult since they have to be routed through and in accordance with a particular cabinet structure.

In other circumstances, bracketry has been mounted underneath a work surface to provide a fixed mounting point for a CPU. This bracketry requires a certain amount of substance to adequately hold the CPU in place and its affixation to the underside of the work surface has to be robust as well. Thus, installation becomes a drawback in some instances owing to weaknesses in the particular mounting points or difficulties that the end user may experience in approaching the installation project.

Other solutions have been offered for this same problem of storing and locating a CPU case. In one particular instance, U.S. Pat. No. 6,419,198 teaches the use of a rolling support that can compatibly retain a CPU case and to allow it to be moved about underneath a work surface. Difficulties with this concept still exist, however, since the convenience for adjustability of the support unit to the CPU case is not synchronized as between the various support arms. Additionally, considerations for the heft of the CPU and the ease with which it may be moved have not been fully appreciated.

As a result, there still remain some long felt needs with respect to providing a suitable storage device for CPU cases and for increasing the convenience of employing them.

### SUMMARY OF THE INVENTION

The computer trolley of the present invention has provided therein a plurality of support arms that project laterally from a junction and which have mounting surfaces thereon for the retention of a CPU case. Each of the said support arms are in synchronous relationship with each other, that is, movement of one arm causes all of the other arms to pivot about a central junction. The synchronous relationship provides uniform adjustability as between each of the support arms when a CPU case is stored and fitted thereon.

According to one aspect of the present invention, a computer trolley is provided that includes a plurality of generally horizontal arms, a plurality of wheels attached to the arms, a center connector, and a generally vertical surface positioned above each of the arms. The center connector is attached to the plurality of arms and adapted to allow the arms to pivot with respect to each other such that the angle between at least two of the arms can be adjusted. The generally vertical surface is positioned adjacent to the ends of the arms and is adapted to contact a side of a computer positioned on the trolley and above the arms. The generally vertical surface is pivotable about a generally vertical pivot axis so that the vertical surface can be adjusted to be more fully in contact with the side of the computer, regardless of the angular orientation of the arms.

According to another aspect of the present invention, a computer trolley is provided that includes a plurality of generally horizontal arms, a plurality of wheels attached to the arms, a center connector, and a removable center pedestal. The wheels include bottoms that are arranged generally in a horizontal plane positioned underneath the arms. The center connector is adapted to allow the plurality of arms to pivot such that the angle between the arms can be adjusted. The removable center pedestal is adapted to be removably secured to the center connector. When so secured, the pedestal extends vertically downward therefrom generally as far as the horizontal plane defined by the bottom of the wheels. The center pedestal limits the amount of downward flexing of the arms when attached to the center connector.

According to yet another aspect of the present invention, a computer trolley is provided that includes a plurality of generally horizontal arms, a plurality of wheels, and a center connector. The arms are arranged so as to not crisscross each other. The wheels are attached to the plurality of arms generally adjacent ends of the arms. The center connector is adapted to allow the arms to pivot with respect to the center connector so that the angle between the arms can be adjusted.

According to still another aspect of the present invention, a computer trolley is provided that includes a plurality of generally horizontal arms, a center connector, a plurality of ball bearing sets, a plurality of wheel mounts, and a plurality of wheels. The center connector is adapted to allow the arms to pivot with respect to the center connector so that the angle between the arms can be adjusted. The ball bearings are mounted between each one of the arms and the wheel mounts to thereby allow the wheel mounts to rotate about a generally vertical axis. The wheels are rotatably mounted to the wheel mounts. According to other aspects of the present invention, there may be four arms that are provided wherein the center connector defines four separate vertical axes about which each of the plurality of arms is pivotable. The arms may include a plurality of gear teeth attached to their ends opposite the wheels wherein the gear teeth mesh with each other so that movement of one of the arms causes at least one of the other arms to move. The arms, center connector, and wheel may all be made out of plastic. The center pedestal may also include a bottom surface that is shaped generally like at least a portion of a sphere. The wheels may be shaped to have a non-flat peripheral surface, such as the surface found on the wheels of conventional in-line skates.

According to its various aspects, the present invention provides a computer trolley that has an increased ease of use for storing and manipulating computer cases. The trolley can be easily fitted to computer cases of different sizes. Further, the trolley provides an ease of rolling, the ability to support large weights, and a high degree of durability. These and other attributes of the present invention will be apparent to one skilled in the art in light of the following written description and the accompanying drawings.

### BRIEF DESCRIPTION OF THE DRAWINGS

FIG. 1 shows a computer trolley of one embodiment of the present invention in a perspective view with a CPU case installed thereon in phantom;

FIG. 2 is a side perspective view of the computer trolley of FIG. 1;

FIG. 3 is a bottom perspective view of the computer trolley of FIG. 1;

FIG. 4 is an exploded perspective view of an outer end of a support arm and a corner and wheel assembly for the computer trolley of FIG. 1;

FIG. 5 is a top perspective view of the inner ends of the support arms as installed on a portion of a central connector;

FIG. 6 shows two perspective views of the components of the central connector of the present invention as they related to each other in mirror image orientation and just prior to assembly;

FIG. 7 is a side perspective view of the inner ends of the support arms in the present invention, with the corresponding components of the central connector assembly orientation;

FIG. 8 is a side perspective view of a pedestal support; and

FIG. 9 is a front, elevational view of a wheel and axle which may be used in the present invention.

### DETAILED DESCRIPTION OF THE INVENTION

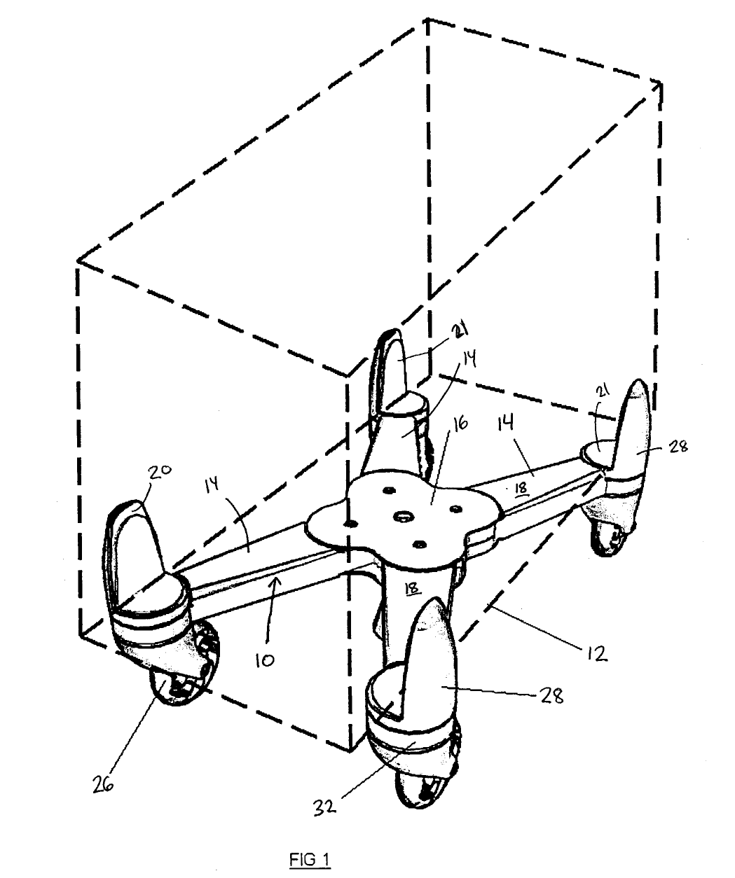

The present invention will now be described with reference to the accompanying drawings wherein the numbered elements appearing in the following written description correspond to like numbered elements in the several drawings. A computer trolley 10 according to one aspect of the present invention is depicted in FIG. 1. Trolley 10 is adapted to store and retain objects, such as computer cases. Trolley 10 is illustrated in FIG. 1 with a computer case 12 (in phantom) supported thereon. Trolley 10 includes four support arms 14 that extend outwardly from a central connector 16. The support arms 14 include a top surface 18 which may contact the underside of the computer case. Support arms 14 are pivotally attached to central connector 16 so that their angular orientation with respect to each other can be adjusted. This adjustment allows trolley 10 to accommodate differently sized computer cases 12. After a computer case 12 is positioned on trolley 10, the arms 14 are adjusted so that the vertical surfaces 20 abut against the sides of the computer case 12. A plurality of wheels 18 attached to the outer ends of arms 14 allow the trolley to be easily moved to any desired position. Wheels 26 are supported on rotatable casters so that trolley 10 can be pushed or pulled in any desired direction. Trolley 10 provides a convenient, durable, lightweight trolley for transporting and moving conventional computers.

Each of the arms 14 includes an inner end 22 and an outer end 24. Inner ends 22 are pivotally attached to center connector 16. Outer ends 24 have wheels 26 mounted thereon, as well as rotatable corner bodies 28. Rotatable corner bodies 28 include vertical surfaces 20, as well as horizontal surfaces 30. Both vertical and horizontal surfaces 20 and 30 may include cushioning material 21 secured thereto in order to help prevent scratching of the computer case by trolley 10. The cushioning may be secured in any conventional fashion. The cushioning also helps provide a grip on the computer case so that the angular orientation of arms 14 tends to remain in whatever orientation they have been manually moved to.

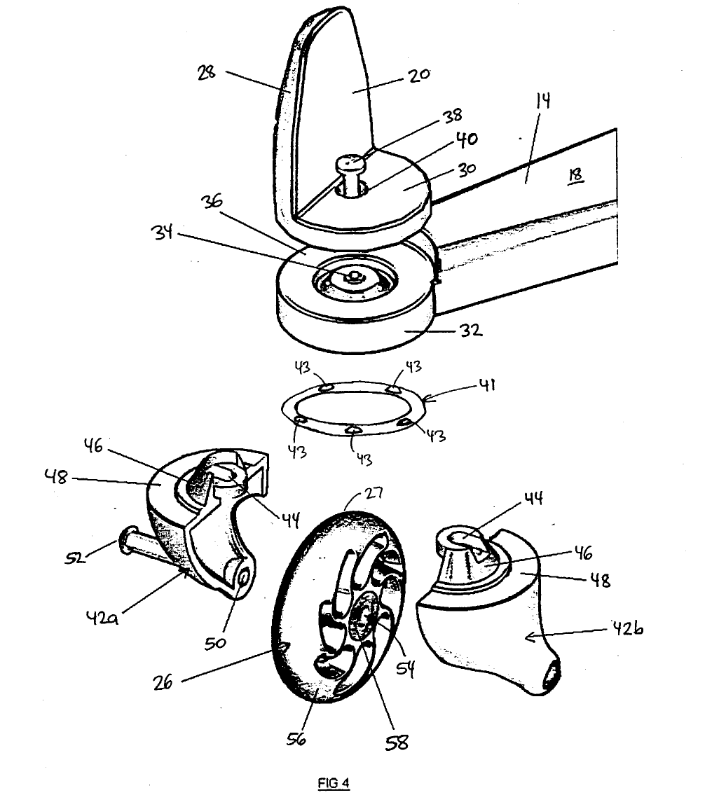

The attachment of rotatable corner bodies 28 to arms 14, as well as the attachment of wheels 26 to arms 14, is illustrated in more detail in FIG. 4. Each arm 14 includes a circular end face 32. A vertical aperture 34 is defined generally in the center of end face 32. Vertical aperture 34 extends completely through end face 32 from its bottom side to its topside. End face 32 includes a top surface 36 about which the bottom surface of the rotatable corner body 28 rotates. Rotatable corner bodies 28 are secured to end faces 32 by way of bolts 38. Bolts 38 pass through vertical aperture 34 and end face 32 and a vertical aperture 40 defined in rotatable corner bodies 28. Bolts 38 secure rotatable corner bodies 28 to end faces 32 of arms 14. This securement, however, is not so tight as to prevent rotatable corner bodies 28 from rotating about the axis defined by bolts 38. Stated alternatively, rotatable corner bodies 28 are rotatable on top surface 36 of end faces 32. The rotation of corner bodies 28 allows the orientation of vertical surface 20 to be changed. Vertical surface 20 can thereby be oriented generally parallel, and in contact with, the sides of a computer housing, regardless of the width of the computer housing.

Wheels 26 are secured to the bottom of end faces 32 by way of a pair of mounting caps 42 (FIG. 4) that define a wheel mount. Each mounting cap 42a and b includes a vertical aperture 44 which vertically aligns with apertures 40 and 34 when mounting caps 42 are secured to arms 14. Each mounting cap 42 includes a portion of a frusto-conical surface 46. When mounting caps 42a and b are secured together, frusto-conical surface portions 46 join together to form a complete frusto-conical surface. This frusto-conical surface extends vertically into a correspondingly shaped recess (not shown) in the bottom of circular end face 32 of arm 14.

Mounting caps 42 further include an arcuate horizontal surface 48. Horizontal surfaces 48 may either directly contact the underside of circular end faces 32, or, more preferably, a ball bearing ring 41 having ball bearings 43 secured therein may be placed between horizontal surfaces 48 and the underside of end faces 32 (FIG. 4). In either case, mounting caps 42a and b are rotatable about the generally vertical axis defined by bolt 38. This rotation allows the orientation of the axle on wheels 26 to be altered, and is independent of the rotation of rotatable corner bodies 28. Trolley 10 can thus be moved in any direction on a floor, or other surface, and the wheels 26 will rotate so that they are aligned with the direction of motion. Ball bearing ring 41, if provided, eases the ability of the wheel mounts to rotate about a generally vertical axis. Ball bearings 43 may be precision ball bearings having diameters that are within 0.5 thousandths of an inch of each other, although other degrees of precision may be used.

Each mounting cap 42 further includes a horizontal aperture 50. An axle 52 for wheels 26 fits through horizontal apertures 50, as well as a horizontal aperture 54 defined in the center of wheel 26 in order to rotatably secure wheel 26 to mounting caps 42. Wheel 26 is rotatable about the axis generally defined by the longitudinal extent of axle 52.

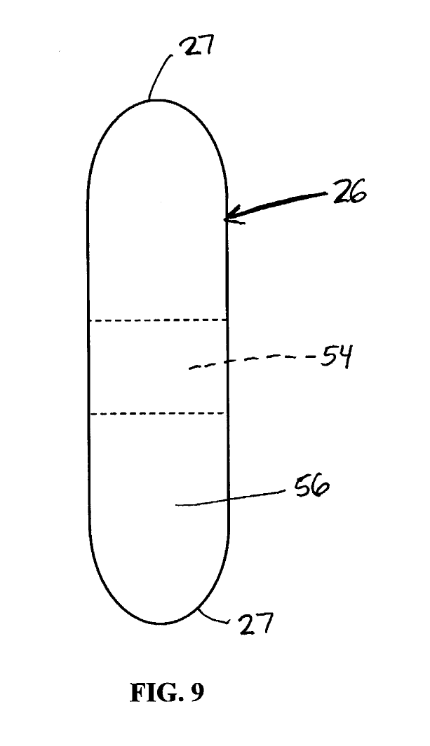

Wheels 26 each include an outer body 56 and a central bearing 58 mounted in the center of the outer body 56. Wheels 26 are preferably shaped in the same manner as conventional in-line skates. That is, each wheel generally has a non-flat bottom profile. As illustrated in FIG. 9, each wheel 26 includes an exterior or peripheral surface 27 that is curved. In the absence of excess loading, contact with the flat ground is therefore limited to only a small portion or point on peripheral surface 27.

Bearings 58 may simply be defined by an internal, cylindrical surface that engages a pin defining axle 52. In this case, the bearings 58 are preferably made of a plastic while the pin is made of metal, such as steel, to provide a suitable ease of rolling for wheel 26. Alternatively, bearings 58 may be of the precision type commonly employed in the wheels of recreational, in-line skates, such as Roller Blades. The use of precision bearings of the in-line type of wheel increases the ease with which trolley 10 rolls. In-line bearings provide superior service as compared to solid body, non-bearing rollers and/or wheels.

The outer bodies 56 of wheels 26 may be molded from a plastic resin that is the same as, or comparable to, plastic resins that are used in the wheel bodies of recreational, in-line skates. In the current embodiment of the present invention, polyurethane is used to mold the wheel bodies 56. Other types of plastic resins may, of course, be used. The plastic resin may be mixed with other materials to produce a wheel having a selected durometer that is suitable for gripping whatever surface trolley 10 is intended to be used on.

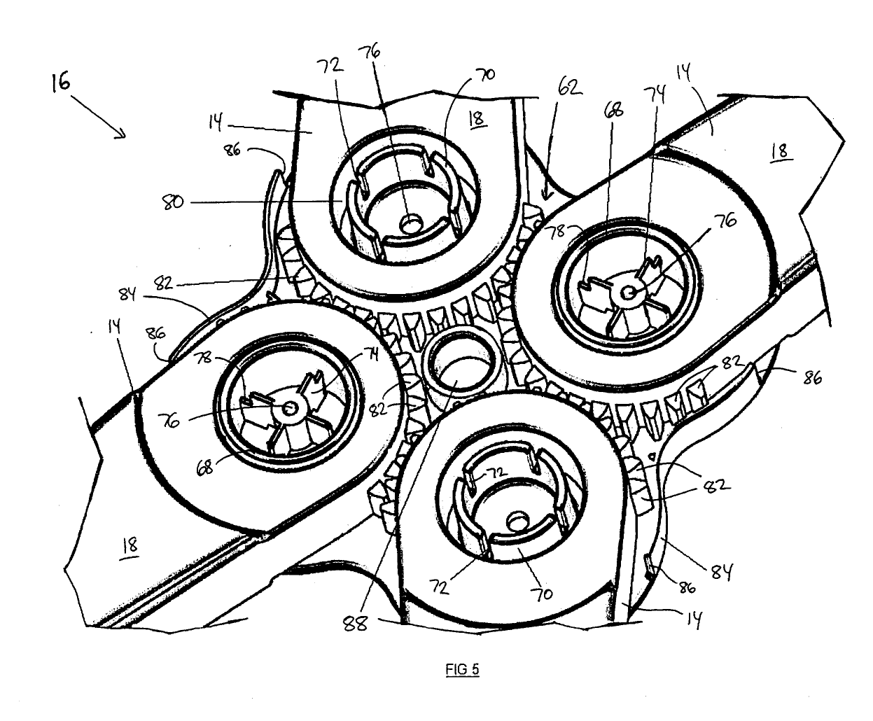

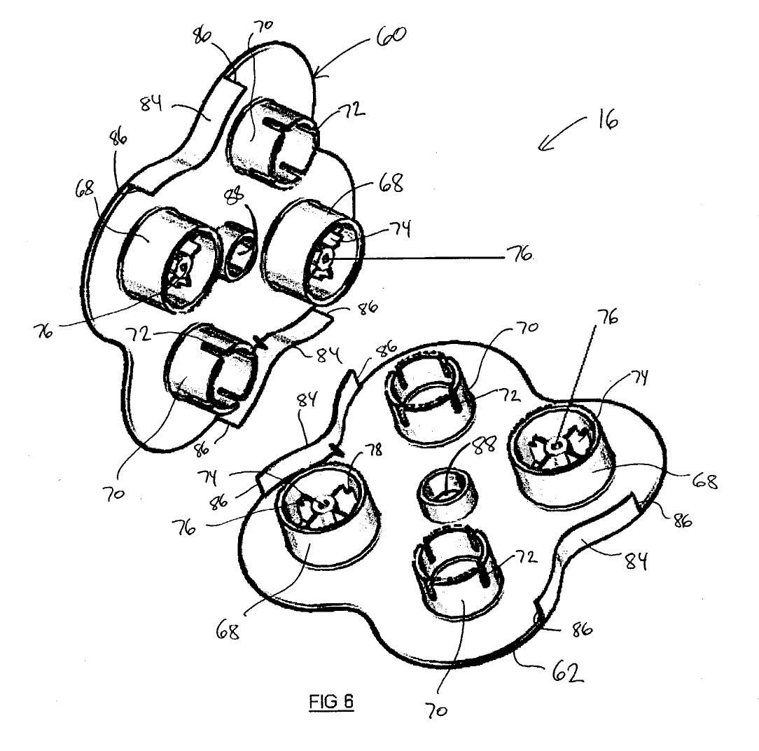

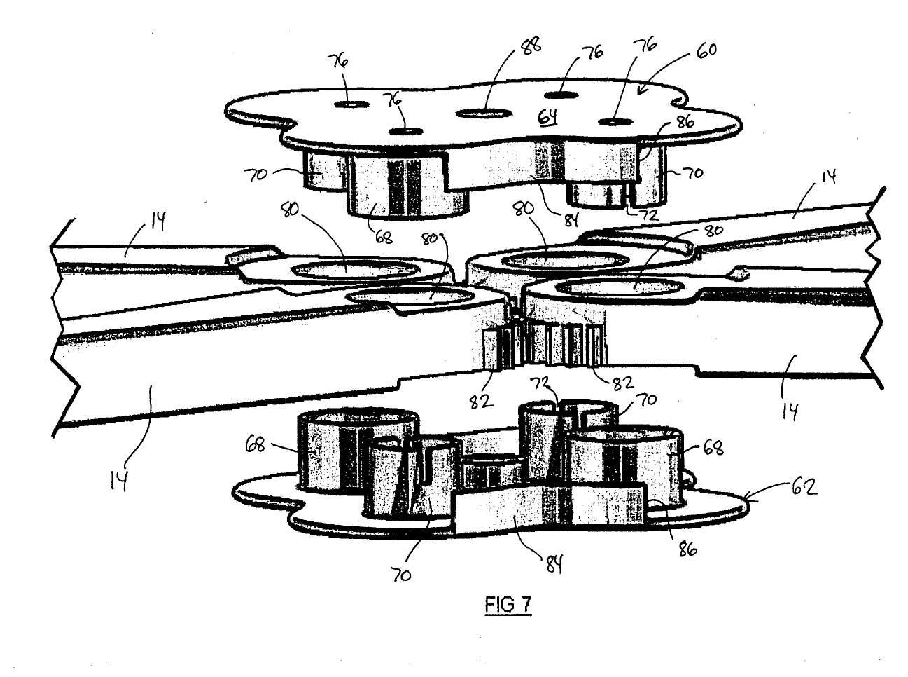

As has been noted, the ends of arms 14 opposite circular end faces 32 are attached to center connectors 16. This interconnection is depicted in more detail in FIGS. 5-7. Center connector 16 includes an upper half 60 and a lower half 62. Upper half 60 includes a flat, top surface 64 that is generally flush with the top surface of arms 14 when center connector 16 is secured to arms 14. Similarly, lower half 62 includes a bottom surface 66 that is generally flush with the bottom surface of arms 14 when center connector 16 and arms 14 are secured together. A pair of diagonally positioned large cylindrical walls 68 extend upward from lower half 62 of center connector 16 from a side opposite bottom surface 66. A pair of small cylindrical walls 70 also extend upwardly from lower half 62 of center connector 16. Small cylindrical walls 70 are also diagonally positioned with respect to each other. Large and small cylindrical wall 68 and 70 are generally positioned at the corners of an imaginary square. Small cylindrical walls 70 include a plurality of slots 72 that extend vertically downward from the top of wall 70. Large cylindrical wall 68 encloses a plurality of fins 74 that are disposed centrally within large cylindrical wall 68. Fins 74 extend radially outward from a central aperture 76. Each fin 74 includes a shortened height portion 78 that is positioned at the periphery of the fin and adjacent to the large cylindrical wall 68.

Top half 60 of center connector 16 is constructed the same as lower half 62. When upper and lower halves 60 and 62 of center connector 16 are secured together, which takes place by moving them vertically towards each other, the small cylindrical walls 70 of one half fit into the large cylindrical walls 68 of the other half. Further, the fins 74 of one half fit into the slots 72 defined in the small cylindrical walls 70 of the other half. Fasteners, such as screws or the like, are inserted into central aperture 76 to maintain the upper and lower halves 60 and 62 of center connector 16 together.

Before upper and lower halves 60 and 62 of center connector 16 are secured together, arms 14 are positioned in contact with one of halves 60 and 62. Each arm 14 includes a circular hole 80 defined at its end opposite end face 32. Circular holes 80 have a diameter that is slightly larger than the outer diameter of large cylindrical walls 68. Arms 14 are positioned in center connector 16 so that circular holes 80 surround each large cylindrical wall 68. Because the diameter of circular hole 80 is slightly greater than the outer diameter of large cylindrical wall 68, each arm 14 is able to rotate about a large cylindrical wall 68. This rotation takes place around a vertical axis, which is centered at, and runs through, central aperture 76. Each of the four arms 16 is thus pivotable about a separate vertical axis.

Each of the ends of arms 14 adjacent circular holes 80 further include a plurality of teeth 82. Large cylindrical walls 68 are positioned in center connector 16 at appropriate distances from each other so that the teeth 82 of each arm 14 will engage the teeth of two adjacent arms 14. Teeth 82 ensure that when a single arm 14 is rotated about its vertical axis, defined through central aperture 76, this will cause the two adjacent arms 14 to also rotate about their respective vertical axes. Further, these two arms will also cause the fourth arm 14 to rotate about its vertical axis through the engagement of its teeth 82 with the teeth of the other two arms 14. Thus, if one arm 14 is moved outwardly to accommodate a relatively wide computer case, all of the other three arms will also pivot outwardly due to the interaction of their teeth 82.

Upper and lower halves 60 and 62 of center connector 16 further include a pair of sidewalls 84. Each sidewall 84 includes two ends 86. Ends 86 of sidewalls 84 limit the amount of outward pivoting of the arms 14. Specifically, arms 14 can be pivoted outwardly only until the sides of the arms 14 abut against ends 86. Thereafter, ends 86 prevent any further outward pivoting of arms 14. The position of ends 86 of sidewalls 84 can be set at any desired location to allow any desired maximum extent of pivoting of arms 14.

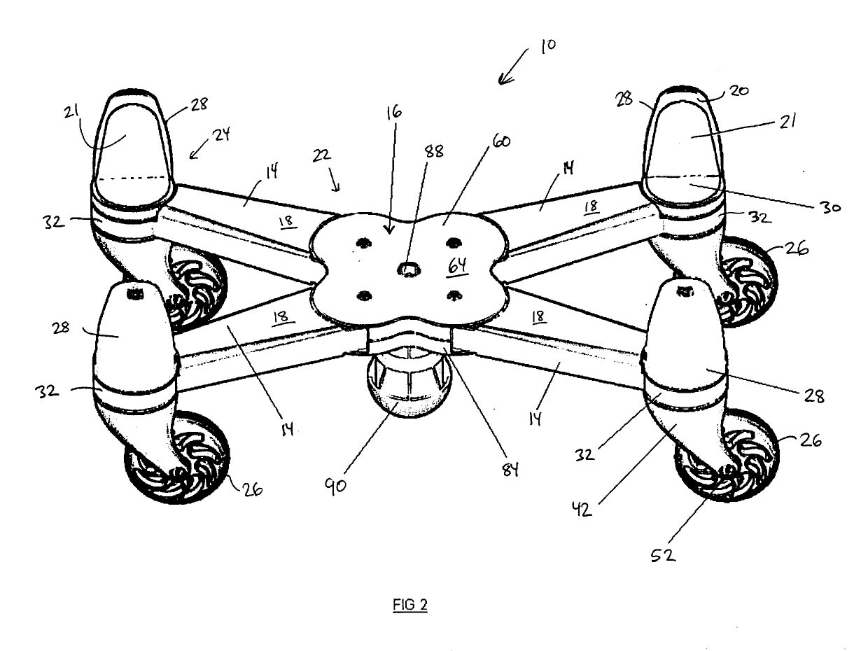

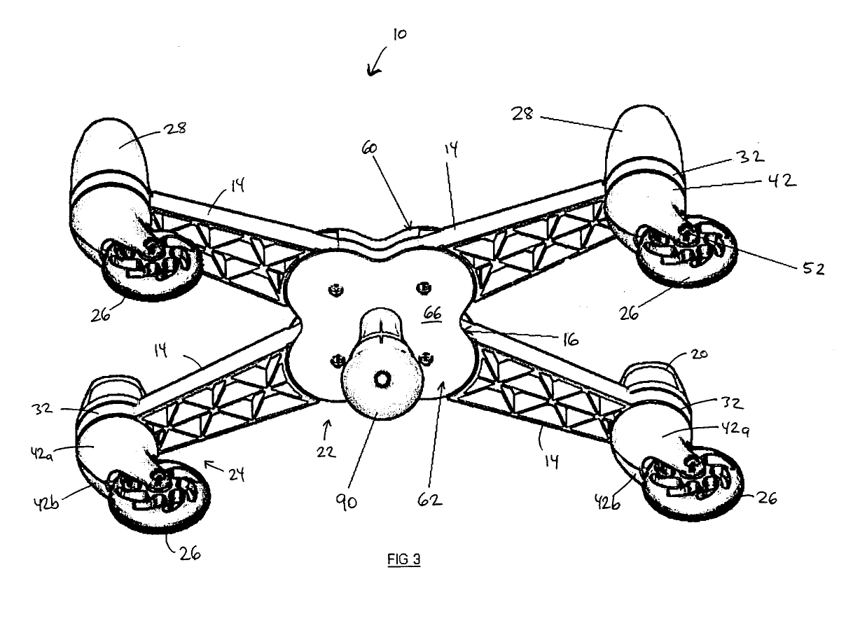

Upper and lower halves 60 and 62 further include a center hole 88 positioned generally in their centers. Center hole 88 is dimensioned to removably receive an optional pedestal 90 (FIGS. 2-3 and 8). Pedestal 90 extends vertically downward from the bottom surface 66 of lower half 62 when it is used. Pedestal 90 provides additional support to trolley 10 if an especially heavy computer case, or other item, is being supported. Pedestal 90 extends downwardly almost as far as the bottoms of wheels 26. Specifically, the bottom of pedestal 90 may terminate about one eighth of an inch above the plane defined by the four bottom points of wheels 26. This clearance helps prevent the bottom of pedestal 90 from unduly inhibiting the ease of motion of trolley 10. When an especially heavy load is positioned on trolley 10, the arms 14 will flex sufficiently to allow the bottom surface of pedestal 90 to come in contact with the floor. Pedestal 90 will therefore help support the load carried by trolley 10.

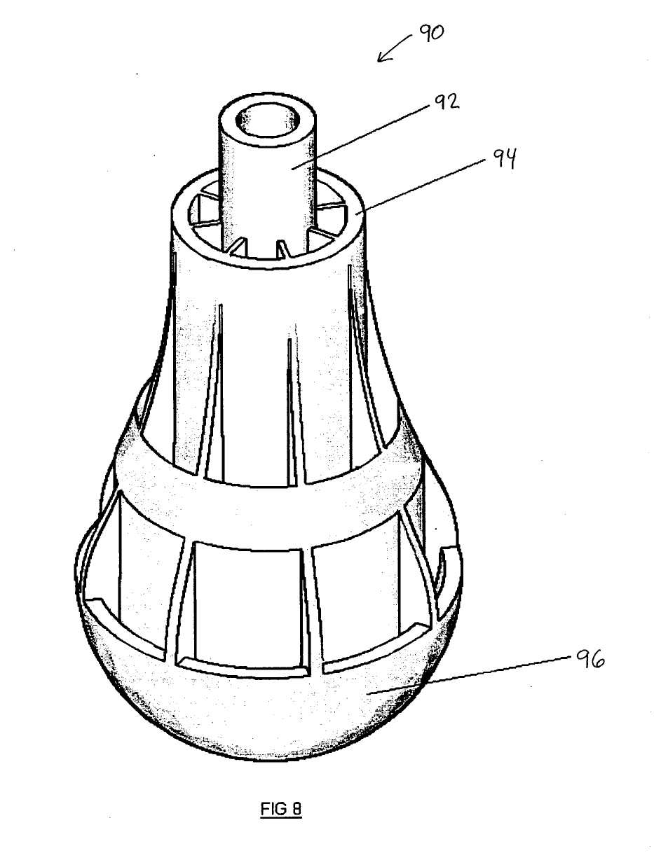

Pedestal 90 includes an upper plug 92 (FIG. 8) that is dimensioned to fit into center hole 88. Upper plug 92 may have an outer surface whose diameter is sufficiently close to the inner diameter of center hole 88 so that pedestal 90 will be frictionally retained in center hole 88. However, pedestal 90 can be easily removed by a user from center hole 88 by simply pulling it out of center hole 88, if pedestal 90 is not desired to be used. Pedestal 90 further includes a shoulder 94 that limits the depth at which plug 92 may be inserted into center hole 88. The bottom 96 of pedestal 90 is generally spherically shaped in order to ease the movement of trolley 10 over a variety of different types of surfaces.

While a variety of different materials may be used to manufacture trolley 10, the arms 14, center connector 16, rotatable corner bodies 28, mounting caps 42, and pedestal 90 are all molded out of nylon. Axles 52 may be made of metal or any other suitable material. Similarly, the fasteners used to secure upper and lower halves 60 and 62 of center connecter 16 together may be any conventional fastener made of metal, or other suitable material. The fastener or fasteners used to rotatably secure corner bodies 28 and mounting caps 42 to arms 14 may also be made out of metal, or any other suitable material.

While the present invention has been described in terms of the preferred embodiments depicted in the drawings and discussed in the specification, it will be understood by one skilled in the art that the present invention is not limited to these particular preferred embodiments, but includes any and all such modifications that are within the spirit and scope of the present invention as defined in the appended claims.

What is claimed is:

1. A computer trolley comprising:
a plurality of generally horizontal arms having first and second ends;
a plurality of wheels attached to said plurality of generally horizontal arms;
a center connector attached to said plurality of arms and adapted to allow said plurality of arms to pivot with respect to said center connector such that the distance between the first ends of at least two of said arms can be adjusted; and
a generally vertical surface positioned above each of said arms and adjacent to said first end of said arms, said generally vertical surface adapted to contact a side of a computer positioned on said trolley and above said arms, said generally vertical surface being pivotable about a generally vertical pivot axis.

2. The trolley of claim 1 wherein said plurality of generally horizontal arms includes four arms.

3. The trolley of claim 2 wherein said center connector defines four separate vertical axes about which each one of said plurality of arms is pivotable.

4. The trolley of claim 1 wherein each of said wheels is made of plastic and includes a set of precision ball bearings.

5. The trolley of claim 1 wherein said plurality of arms are arranged so as to not criss-cross each other.

6. The trolley of claim 5 wherein one of said wheels is attached to said first end of each arm, and a plurality of gear teeth are attached to said second end of each arm, said gear teeth of said arms meshing with each other so that movement of one of said arms causes at least one other of said arms to move.

7. The trolley of claim 1 wherein said arms, said center connector, and said wheel are all made out of plastic.

8. The trolley of claim 1 further including a removable center pedestal, said pedestal adapted to be removably secured to said center connector, said pedestal extending vertically downward from said center connector generally as far as a horizontal plane defined by bottoms of said wheels, said removable center pedestal limiting the amount of downward flexing of said arms when attached to said center connector.

9. The trolley of claim 8 wherein said removable center pedestal includes a generally rigid bottom surface that is shaped generally like at least a portion of a sphere.

10. The trolley of claim 1 wherein said wheel are mounted on rotatable casters, said rotatable casters secured to said first ends of said plurality of arms.

11. The trolley of claim 1 wherein said arms criss-cross each other and said center connector is a pin which pivotally secures said arms together.

12. A computer trolley comprising:
a plurality of generally horizontal arms having first and second ends;
a plurality of wheels attached to said plurality of generally horizontal arms, said wheels including bottoms that are arranged generally in a horizontal plane positioned underneath said plurality of arms;
a center connector attached to said plurality of arms and adapted to allow said plurality of arms to pivot with respect to said center connector such that the distance between the first ends of at least two of said arms can be adjusted; and
a removable center pedestal adapted to be removably secured to said center connector, said pedestal extending vertically downward from said center connector generally as far said horizontal plane, said removable center pedestal limiting the amount of downward flexing of said arms when attached to said center connector.

13. The trolley of claim 12 wherein said removable center pedestal includes a generally rigid bottom surface that is shaped generally like at least a portion of a sphere.

14. The trolley of claim 12 wherein said plurality of generally horizontal arms includes four arms and said center connector defines four separate vertical axes about which each one of said plurality of arms is pivotable.

15. The trolley of claim 12 wherein each of said wheels is made of plastic and includes a set of precision ball bearings.

16. The trolley of claim 12 wherein said plurality of arms are arranged so as to not criss-cross each other.

17. The trolley of claim 16 wherein one of said wheels is attached to said first end of each arm, and a plurality of gear teeth are attached to said second end of each arm, said gear teeth of said arms meshing with each other so that movement of one of said arms causes at least one other of said arms to move.

18. The trolley of claim 17 wherein said arms, said center connector, and said wheel are all made out of plastic.

19. The trolley of claim 18 further including a generally vertical surface positioned above each of said arms and adjacent to said first end of said arms, said generally vertical surface adapted to contact a side of a computer positioned on said trolley and above said arms, said generally vertical surface being pivotable about a generally vertical pivot axis.

20. The trolley of claim 12 wherein said arms criss-cross each other and said center connector is a pin which pivotally secures said arms together.

21. A computer trolley comprising:
a plurality of generally horizontal arms having first and second ends, said plurality of arms being arranged so as to not criss-cross each other;
a plurality of wheels attached to said plurality of arms generally adjacent said first ends of said arms; and
a center connector attached to said second ends of said plurality of arms and adapted to allow said plurality of arms to pivot with respect to said center connector such that the distance between the first ends of at least two of said arms can be adjusted.

22. The trolley of claim 21 further including a plurality of gear teeth are attached to said second end of each arm, said gear teeth of said arms meshing with each other so that movement of one of said arms causes at least one other of said arms to move.

23. The trolley of claim 22 wherein said center connector defines four separate vertical axes about which each one of said plurality of arms is pivotable.

24. The trolley of claim 22 wherein each of said wheels is made of plastic and includes a set of precision ball bearings.

25. The trolley of claim 24 further including a removable center pedestal, said pedestal adapted to be removably secured to said center connector, said pedestal extending vertically downward from said center connector generally as far as a horizontal plane defined by bottoms of said wheels, said removable center pedestal limiting the amount of downward flexing of said arms when attached to said center connector.

26. The trolley of claim 25 further including a generally vertical surface positioned above each of said arms and adjacent to said first end of said arms, said generally vertical surface adapted to contact a side of a computer positioned on said trolley and above said arms, said generally vertical surface being pivotable about a generally vertical pivot axis.

27. A computer trolley comprising:
a plurality of generally horizontal arms having first and second ends;
a center connector attached to said plurality of arms and adapted to allow said plurality of arms to pivot with respect to said center connector such that the distance between the first ends of at least two of said arms can be adjusted;
a plurality of wheel mounts positioned adjacent the first ends of said arms;
a wheel rotatably mounted to each one of said plurality of wheel mounts; and
a plurality of ball bearing rings mounted between said first ends of said arms and said wheel mounts to thereby allow the wheel mounts to rotate about a generally vertical axis.

28. The trolley of claim 27 wherein said plurality of generally horizontal arms includes four arms and said center connector defines four separate vertical axes about which each one of said plurality of arms is pivotable.

29. The trolley of claim 28 further including a generally vertical surface positioned above said wheel mounts, said generally vertical surface adapted to contact a side of a computer positioned on said trolley and above said arms, said generally vertical surface being pivotable about the generally vertical pivot axis independently.

30. The trolley of claim 29 of the rotation of said wheel mounts further including a plurality of gear teeth attached to said second end of each arm, said gear teeth of said arms meshing with each other so that movement of one of said arms causes at least one other of said arms to move.

31. The trolley of claim 30 further including a removable center pedestal, said pedestal adapted to be removably secured to said center connector, said pedestal extending vertically downward from said center connector generally as far as a horizontal plane defined by bottoms of said wheels, said removable center pedestal limiting the amount of downward flexing of said arms when attached to said center connector.

32. The trolley of claim 31 wherein said removable center pedestal includes a generally rigid bottom surface that is shaped generally like at least a portion of a sphere.

33. The trolley of claim 27 wherein said arms criss-cross each other and said center connector is a pin which pivotally secures said arms together.

34. A computer trolley comprising:
a plurality of generally horizontal arms having first and second ends;
a center connector attached to said plurality of arms and adapted to allow said plurality of arms to pivot with respect to said center connector such that the distance between the first ends of at least two of said arms can be adjusted;
a plurality of axles positioned generally adjacent said first ends of said horizontal arms; and
a plurality of wheels mounted for rotation about said plurality of axles, each of said wheels including a non-flat peripheral surface adapted to contact the ground when the trolley is positioned thereon.

35. The trolley of claim 34 wherein each one of said wheels is made from a compressible plastic resin.

36. The trolley of claim 35 wherein said resin is polyurethane.

37. The trolley of claim 34 wherein said arms are arranged so as to not criss-cross each other.

38. The trolley of claim 37 wherein there are four arms and each one of said arms is pivotable about a separate vertical axis.

39. The trolley of claim 37 wherein each one of said arms includes a plurality of gear teeth attached to said second end, said gear teeth meshing with each other so that movement of one of said arms causes at least one other of said arms to move.
